(19) United States
(12) Patent Application Publication
(10) Pub. No.: US 2011/0057453 A1
(43) Pub. Date: Mar. 10, 2011

(54) TETHERED AIRBORNE WIND-DRIVEN POWER GENERATOR

(76) Inventor: Bryan William Roberts, Runaway Bay (AU)

(21) Appl. No.: 12/714,070

(22) Filed: Feb. 26, 2010

Related U.S. Application Data
(60) Provisional application No. 61/155,561, filed on Feb. 26, 2009.

(51) Int. Cl. F03D 9/00; B64C 31/06

(52) U.S. Cl. 290/55; 244/153 A

(57) ABSTRACT

A tethered airborne wind-driven power generation device providing, in various embodiments, a main tether and plurality of auxiliary tethers, feedback controls for continuously adjusting pitch, roll and yaw, and a Vee-shaped configuration for disposing rotors along the frame of the device. The auxiliary tethers avoid slack and resultant transient instability, and the Vee-shaped rotor disposition takes advantage of upwash or any other aerodynamic benefit from the rotors adjacent to it, to improve efficiency.

### CROSS-REFERENCE TO RELATED APPLICATIONS

This application claims priority based upon, and the benefit of the filing date of, U.S. Provisional Application No. 61/155,561, filed Feb. 26, 2009, which is hereby incorporated by reference in this application, in its entirety.

### BACKGROUND OF THE INVENTION

1. Field of the Invention

The invention is in the fields of wind power generation and aeronautics, and more particularly concerns a tethered airborne wind-driven power generation device preferably having tethers and a rotor layout arranged for stability and efficiency.

2. Description of the Related Art

The types of power-generation devices in the field of the present invention are airborne devices tethered to a substantially fixed point on the ground, having wind-driven rotors that drive dynamos (reversible generators that can also act as motors, operating either on AC or DC), or other power-conversion apparatus, to extract energy from atmospheric wind.

The purpose of incorporating the wind-driven rotors in a tethered airborne device is to enable them to be positioned at a high altitude where relatively strong and continuous winds may be expected to be found. Conventionally, the dynamos on the airborne devices generate electricity, which is transmitted to the ground for distribution through cabling constituting or associated with the devices' tethers.

Reference is made to a prior patent of mine in this field, U.S. Pat. No. 6,781,254, entitled “Windmill Kite”, the entire disclosure of which is hereby incorporated by reference. The '254 patent explains the background of tethered airborne wind-driven power generation technology, and sets forth a solution in which at least three substantially axially co-directed, spaced apart mill rotors are mounted into an assembly or unit; a platform frame supports the mill rotors and is tiltable upwards by a predetermined angle with reference to the horizontal; at least one tether line maintains a substantially fixed location of the platform relative to the ground; at least one winch at ground level enables the kite to be reeled in or let out in order to adjust its altitude as needed; at least one dynamo is mounted to the platform and connected to an output of the mill rotors; a conductor connects the dynamo(s) to an electrical supply at ground level; an electrical system controller allows electrical energy produced by the dynamo to be distributed into an electrical system; and a platform positioner is mounted to the platform and configured to control the pitch angle on blades of the mill rotors to maintain the attitude of said platform relative to a fixed set of orthogonal axes.

In an example embodiment described in the '254 patent, there were at least three substantially axially co-directed, spaced apart mill rotors disposed in an array which was symmetrical in terms of thrust capacity about each of two orthogonal axes, namely an X axis extending longitudinally of the platform, and a Y axis extending transversely of the platform, and was neutral in terms of torque capacity about a third orthogonal axis, namely a Z axis perpendicular to the X and Y axes. Blade pitch control means provided for adjustment of the angles of attack of the blades of the respective mill rotors, to thereby stabilize the platform in a desired attitude and orientation relative to the wind direction. Differential torque reactions of opposing rotors could also be used to cause rotation relative to the Z axis.

The '254 patent was intended to address shortcomings in the the prior art that, even at high altitudes, winds sometimes fail to blow with sufficient strength to enable the control surfaces to adequately stabilize the flying platform against variables such as wind gusts or eddies. Thus, should the wind fail, it had been necessary for the platform to be winched down to prevent the tethering lines and/or conductive cables from becoming tangled, and, in a worst case scenario, to prevent the platform from crashing. Winching the platform down and subsequently returning it to an operating altitude is a time consuming and expensive operation. An electrical system controller was configured to generate error signals in response to the platform's orientation, altitude or position moving from a predetermined orientation, altitude or position. There could be a greater even number of mill rotors in counterrotating pairs. The '254 patent discloses X and Y axis adjustments by differential pitch adjustment of such counterrotating pairs. It also discloses supplying electricity in reverse, from the ground to the mill rotors, to rotate the rotors and provide lift. Furthermore, the mill rotors themselves were tiltable from the horizontal.

However, while the '254 patent discusses arrangements involving at least one tether, it does not address the possibility, where multiple tethers are used, of slack developing in one of these that could result in transient instability. Nor does the '254 patent address modes of arranging the rotors relative to each other that might improve efficiency.

### SUMMARY OF THE INVENTION

It is an object of the present invention to provide a tethered airborne wind-driven power generation device providing more secure tethering, lower frame stresses on the platform and higher power production efficiency.

In one aspect, these objectives are achieved by providing a plurality of rotors arranged symmetrically on the leading edges of a generally polygonal, planar, frame, and having a main tether to the ground and a plurality of auxiliary tethers joining the vertices of the frame to a single point of attachment to the main tether. The rotors incorporate differential thrust controls providing continuous feedback adjustment for all three of pitch, roll and yaw. The fact that there are a plurality of auxiliary tethers avoids slack and any resulting transient instability. In one embodiment, the frame may be triangular; in this or other embodiments, the number of auxiliary tethers used may be three.

In another aspect, the rotors are set out in a “Vee”-shaped arrangement so that their interaction through up-wash or any other aerodynamic benefit will improve the efficiency of the overall rotor array.

In a further aspect, stabilizing and/or steering members may be added to the assembly.

Other aspects and advantages of the invention will be apparent from the accompanying drawings, and the detailed description that follows.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 is top perspective view of an exemplary embodiment of the invention having four rotors. Details of dynamos and associated parts have been deleted from the figure for clarity.

FIG. 2 is a plan view of the embodiment shown in FIG. 1.

FIG. 3 is a plan view of an alternate embodiment having six (or alternatively more) rotors.

FIG. 4 is a side elevation view of a further embodiment having six (or alternatively more) rotors and a rudder/downwash vane assembly.

FIG. 5 is a plan view of the embodiment depicted in FIG. 4.

### DETAILED DESCRIPTION OF PREFERRED EMBODIMENTS

The following is a detailed description of certain embodiments of the invention chosen to provide illustrative examples of how it may preferably be implemented. The scope of the invention is not limited to the specific embodiments described in the following detailed description, nor is it limited by any specific implementation, embodiment or characterization depicted in the accompanying drawings or stated or described in the invention summary or the abstract. In addition, nothing contained in this written description should be understood to imply any necessary order of steps where processes are described, except as may be specified by express claim language.

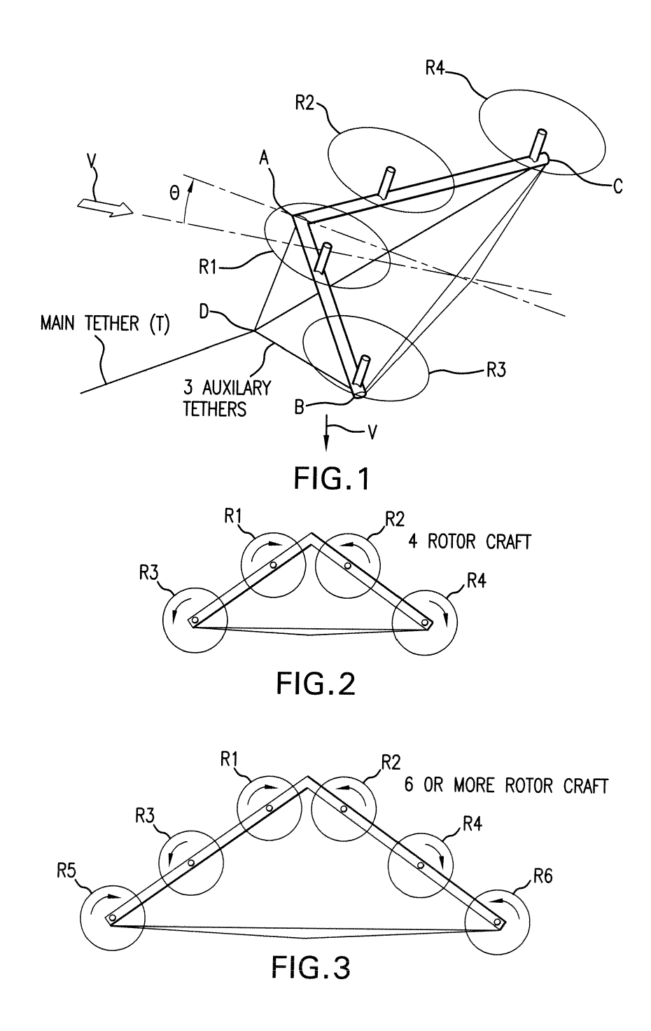

Referring to FIGS. 1 and 2, a triangular fuselage of frame ABC can carry three or more windmill rotors, or mills, R1-R4 (etc.), arranged along the members AB and AC respectively. The fuselage structure has been drawn in the supporting figures showing tubular members. These members could be a framed structure or fabricated from composite materials into any suitable shape to support the rotor system as drawn. In other embodiments (not shown) the fuselage may be shaped differently (e.g., as rectilinear, or other generally polygonal, planar, frame or platform), and a different number of auxiliary tethers employed; similarly, an arrangement employing three auxiliary tethers with a triangular set of attachment points to the frame could be utilized, even though the frame has a different outline than the pattern of the attachment points.

The mill rotors as shown are reversible machines. On the one hand, wind directed through the swept area of the blades induces a continuous rotor torque, enabling the mill rotor to, for example, drive an associated dynamo as a generator. On the other hand, rotation of the mill rotor in still or low velocity air by a dynamo acting as a motor induces a continuous air flow through the swept area producing a thrust force, enabling the mill rotor to, for example, lift itself and the dynamo from the ground. (It should be noted that motors and/or generators will also be attached to the shafts of rotors R1, etc., and may further include gearboxes. For purposes of keeping the accompanying drawings clear with regard to the depicted features, these further elements are not shown, but their manner of integration should be clear to those skilled in the art.)

Each wind driven rotor R1-R4 (referred to herein as “a mill rotor”) may comprise a rotatable hub and a plurality of equi-angularly spaced blades extending radially from the hub. Preferably each blade is of airfoil section and a blade pitch control is provided in the hub as a means by which the angle of attack of the blades may be adjusted from time to time. This action produces differential thrust changes from the rotors, thereby changing pitch, roll and yaw attitudes.

The mechanical energy from the rotors may be converted into another form of energy, for example, electrical energy, by at least one transducer. In the exemplary embodiment, the transducer is a dynamo. In this embodiment, the electrical energy is transferred to (and alternately from) the ground by a conductor, which may constitute or be associated with, one or more tethers. Any other means of energy transfer may be employed as well, such as laser beams, waveguides, or physical transfer of batteries, capacitors, fluids or compositions of matter capable of storing energy, along any cable, conductor, conduit or other path.

The airborne device has at least one sensor for monitoring for pitch, roll and yaw of the frame. The differential thrust action of the rotors is made responsive to the output of said sensors, to provide continuous feedback-controlled attitude adjustment.

Referring again to FIGS. 1 and 2, these rotor mills can be used, via differential collective pitch action, to control altitude, pitch, roll and yaw of the craft. The craft is restrained by a single main tether T reaching from the ground to the point D. Three auxiliary tethers, namely AD, BD and CD, extending respectively from points A, B and C, all meet at the tether confluence point D.

With three auxiliary tethers as in the above-described embodiment there is no possibility of any auxiliary tether going slack, so long as there is tension in the main tether. In addition, the tether attachment points A, B and C are outboard of the rotor assemblies, reducing the bending stresses in members AB and AC.

The triangular-shaped fuselage frame ABC is positioned in an air stream of velocity V, at a nose-up angle of θ to the air stream. This nose-up attitude results in power being extracted from the air stream, while the craft is simultaneously held aloft.

Pitch control is achieved by varying the thrust differentially between rotors R1,R2 and rotors R3,R4 in the four rotor embodiment. FIG. 3 shows an embodiment having six rotors (representative of any embodiment with six or more rotors). In a six rotor embodiment, pitch control is achieved between groups R1,R2 and R5,R6 acting differentially.

In embodiments having six or more rotors the spacing of the various groups of rotors, e.g., R1 and R3 as compared to R3 and R5, along the underlying device framework, is not critical. In addition, in all embodiments, the heights of the individual rotors above the fuselage frame can vary, as can the sweep angle members AB, AC back from perpendicular to the directional axis of the assembly (see FIG. 5 for how the sweep angle is specified), and the shapes of these members. These dimensions and shapes can be configured from wind tunnel tests to maximize or optimize the lift and/or power output of the assembly.

Similarly, roll control is achieved by differential thrust action between R3 and R4 with a four rotor embodiment, or between R5 and R6 with a six rotor embodiment.

Likewise yaw control is achieved by differential torque reactions between rotors R1,R4 and R2,R3 in a four rotor embodiment, or between rotors R1,R5 and R2,R6 in a six rotor embodiment. A conventional vertical stabilizer with or without rudder may be added to assist in yaw stability and control. This addition may be made in both the four and six rotor embodiments.

Altitude control is achieved by equal collective pitch actions on R1,R2,R3 and R4 in a four rotor embodiment, or by equal collective action on R1-R6 with a six rotor embodiment.

All of the foregoing orientation and positioning adjustments can be obtained in a like manner to those obtained in the illustrated four and six rotor embodiments, as should be apparent to those of skill in the art. In addition, it should also be recognized that other rotor combinations having symmetry similar to the rotor combinations disclosed above may be used to perform the various specified operations.

In addition, it is known that birds often fly in an extended Vee-formation not unlike that shown in the arrangement of rotors R1-R6 in FIG. 3. The reason for this (in the case of birds) is that the up-wash or any other aerodynamic benefit from the adjacent lifting surfaces improves the performance of the individual in between. The Vee-shaped rotor configuration as illustrated by FIG. 3 takes advantage of the same phenomenon in order to improve the overall efficiency of the airborne wind-power generation device.

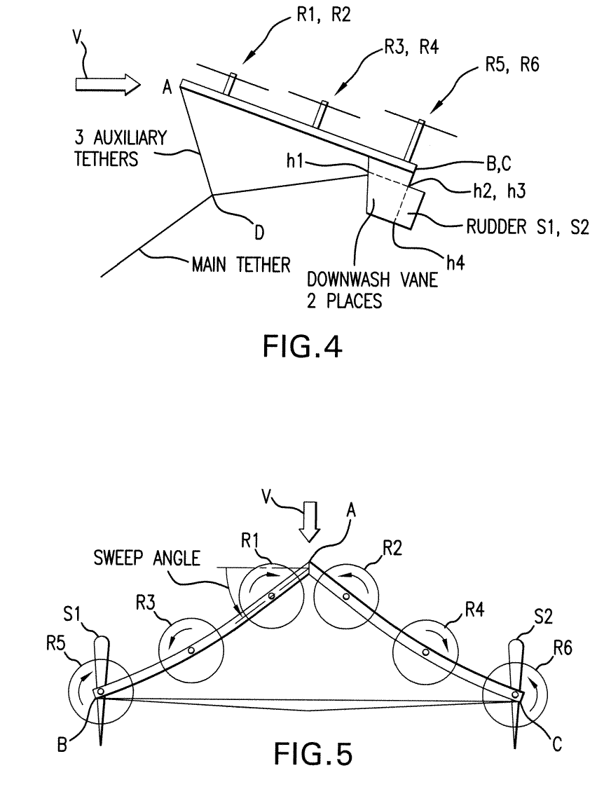

A further embodiment is shown in FIGS. 4 and 5. In this embodiment, the respective rotors, e.g., R1, R3, R5, are mounted successively higher from front to rear, and the lateral Vee members AB and AC are slightly flared outwards relative to the heading direction of the device along the respective opposing frame members running back from the leading vertex (or in other embodiments, along respective opposing lines leading back from the leading vertex). These features take further advantage of the benefits of the Vee configuration, discussed above. In addition, two vertical stabilizers S1, S2 have been added at the respective sides of the rear of the assembly. More or different such elements may be added or substituted. As shown, each comprises an adjustable fin and rudder, hinged about hinge line h3-h4 (i.e., along an axis generally perpendicular to the triangular structure of the device frame), as well as an adjustable downwash vane, hinged along the hinge line h1-h2 (i.e., along an axis generally parallel to the triangular structure of the device frame). These stabilizers are provided to enhance yaw control capabilities of the overall craft in all wind conditions.

As mentioned, the details of the above-described configurations may be changed, whereby the in-line placement of rotors on each side of the device may be varied by small amounts up or down, or back and forth, in order to maximize the advantages of the total assembly. Such maximization may be determined by wind-tunnel tests or similar action.

It is apparent that the present invention meets the objects stated herein. Although the present invention has been described in detail, it should be understood that various changes, substitutions, and alterations may be readily ascertainable by those skilled in the art and may be made herein without departing from the spirit and scope of the present invention as defined by the claims set forth below.

I claim:

1. A tethered airborne wind-driven power generation device comprising:
(a) a frame defining a generally polygonal planar platform having a plurality of vertices, said plurality of vertices comprising at least a leading vertex and opposing left and right side vertices;
(b) a main tether held at its distal end to a substantially fixed position on the ground;
(c) a plurality of auxiliary tethers, each connecting one of said vertices to a confluence point at the proximal end of said main tether, said tethers positioning said frame at an angle whereby said leading vertex generally maintains an upward tilt angle with reference to the horizontal; and
(d) a plurality of rotors, rotatably responsive to wind pressure, said rotors
(i) symmetrically disposed along respective opposing lines from said leading vertex to said left and right vertices, wherein at least one pair of said rotors in opposing positions on said respectivel lines rotate in opposite directions;
(ii) arranged in a Vee-shaped formation along said lines, wherein each rearward rotor is positioned to receive an upwash or any other aerodynamic benefit from one or more rotors adjacent to it.

2. The tethered airborne wind-driven power generation device of claim 1, further comprising
(a) at least one sensor for pitch, roll and yaw of said frame;
(b) differential thrust controls for each said rotor, responsive to said at least one sensor, for correcting the orientation of said frame relative to the longitudinal, transverse and vertical axes of said frame;
(c) at least one transducer mounted to said frame and connected to an output of said rotors; and
(d) a transmission path from said device to the ground for energy output by said at least one transducer.

3. The tethered airborne wind-driven power generation device of claim 1, wherein said frame defines a generally triangular platform.

4. The tethered airborne wind-driven power generation device of claim 1, wherein said plurality of auxiliary tethers comprises three tethers.

5. The tethered airborne wind-driven power generation device of claim 2, wherein said at least one transducer is a dynamo.

6. The tethered airborne wind-driven power generation device of claim 1, wherein each said rotor comprises a rotatable hub and a plurality of equi-angularly spaced blades extending radially from said hub.

7. The tethered airborne wind-driven power generation device of claim 6, wherein said blades are of an airfoil section and said hubs further provide a blade pitch adjustment for said blades.

8. The tethered airborne wind-driven power generation device of claim 2, wherein said transmission path comprises an electrical conductor.

9. The tethered airborne wind-driven power generation device of claim 8, wherein said conductor constitutes one or more of said tethers.

10. The tethered airborne wind-driven power generation device of claim 8, wherein said conductor is associated with one or more of said tethers.

11. The tethered airborne wind-driven power generation device of claim 1, wherein attachment points on said frame for said tethers are outboard of said rotors.

12. The tethered airborne wind-driven power generation device of claim 1, wherein said device has six or more rotors.

13. The tethered airborne wind-driven power generation device of claim 1, wherein each successive rotor from front to rear along said respective lines, beginning with the second such rotor, is elevated higher than the rotor in front of it on said line.

14. The tethered airborne wind-driven power generation device of claim 1, wherein each said line along which said rotors are positioned is flared outward relative to the heading direction of said device.

15. The tethered airborne wind-driven power generation device of claim 1, further comprising a plurality of vertical stabilizing elements.

16. The tethered airborne wind-driven power generation device of claim 15, wherein said vertical stabilizing elements comprise a fin and rudder.

17. The tethered airborne wind-driven power generation device of claim 16, wherein said said fin and rudder are hinged to each other and said rudder is adjustable.

18. The tethered airborne wind-driven power generation device of claim 17, wherein said hinge is oriented along an axis generally perpendicular to the triangular structure of said generally triangular frame.

19. The tethered airborne wind-driven power generation device of claim 15, wherein said vertical stabilizing elements comprise a downwash vane.

20. The tethered airborne wind-driven power generation device of claim 19, wherein said said downwash vane is hinged and adjustable.

21. The tethered airborne wind-driven power generation device of claim 20, wherein said hinge is oriented along an axis generally parallel to the triangular structure of said generally triangular frame.
